(19) United States
(12) Patent Application Publication
(10) Pub. No.: US 2014/0374034 A1
(43) Pub. Date: Dec. 25, 2014

(54) RAIL ANCHOR ASSEMBLY FOR CORDED WINDOW SHADES

(71) Applicant: Comfortex Window Fashions, Maplewood, NY (US)

(72) Inventors: John A. Corey, Melrose, NY (US); Michael Nygard, Malta, NY (US)

(21) Appl. No.: 14/312,765

(22) Filed: Jun. 24, 2014

Related U.S. Application Data
(60) Provisional application No. 61/838,528, filed on Jun. 24, 2013.

(51) Int. Cl. E06B 9/38

(52) U.S. Cl. CPC E06B 9/38
USPC 160/170; 29/428

(57) ABSTRACT

A rail anchor assembly for a corded window shade is disclosed. The rail anchor assembly can include: a spool including a first aperture for allowing a cord of the corded window shade to pass axially into an interior cavity of the spool; and a second aperture for allowing the cord to exit the interior cavity of the spool; and a retaining component for affixing an end of the cord to a component of the window shade other than the spool.

### CROSS-REFERENCE TO RELATED APPLICATIONS

This application claims the benefit of co-pending U.S. provisional patent application No. 61/838,528 filed Jun. 24, 2013, which is hereby incorporated herein.

This application claims priority to previous U.S. Provisional Patent Application No. 61/838,528 filed Jun. 24, 2013, which is hereby incorporated by reference.

### BACKGROUND OF THE INVENTION

1. Technical Field

The disclosure is related generally to window shades. More particularly, the disclosure is related to a rail anchor assembly for a corded window shade assembly.

2. Related Art

Many types of window treatments such as venetian blinds, cellular or pleated shades, and variants (collectively, “window shades”), utilize multiple internal cords for adjusting the position of the window shades. These cords are typically anchored to a movable bottom rail and are threaded through the window shade to a relatively-fixed top rail. The cords may also be attached to a cordlock of the top rail and then disposed out of the top rail and/or exposed to a user of the window shade. More than one such cord is required to provide uniform and level support to the window shade, and wide shades may have three or more such cords. Convenient operation of the shade demands that a single cord be grasped by the user; not a multitude of cords. As such, the exposed cords are conventionally joined together by a coupling to form a single user cord. This coupling is often called an equalizer, because the exposed cords are knotted to the equalizer, giving the manufacturer an opportunity to adjust the effective length of each cord (typically by knot placement), thereby making all the cords share the load. Notably, the task of reliably insuring that all the cords are in fact equally loaded (and the window shade thereby level-hanging once installed) has proven to be difficult in practice and is a significant cause of manufacturing cost, customer complaint and returns for repair or readjustment.

Conventional window shades may utilize cord plug assemblies positioned within the bottom rail to help user's adjust a horizontal position of the bottom rail. These assemblies may be coupled to the cords positioned on opposite sides of the window shade. In equalizing the horizontal position of the bottom rail, these conventional cord plug assemblies may adjust the length of the respective opposite side cords of the window shade to equalize the position of the bottom rail. However, the use of the conventional cord plug assemblies within these window shades presents many issues for users and/or manufacturers. For example, the use of conventional cord plug assemblies requires precise matching of bottom rail holes to the placements of the cord plug assemblies. Also, the complex threading of the cord plug assembly is time-consuming, and makes assembling of the cord plug assembly difficult.

### BRIEF DESCRIPTION OF THE INVENTION

A rail anchor assembly for a corded window shade assembly is disclosed. In one embodiment, the rail anchor assembly includes: a spool including a first aperture for allowing a cord of the corded window shade to pass axially into an interior cavity of the spool, and a second aperture for allowing the cord to exit the interior cavity of the spool; and a retaining component for affixing an end of the cord to a component of the window shade other than the spool.

A first aspect of the invention includes a rail anchor assembly for a corded window shade. The rail anchor assembly includes: a spool including a first aperture for allowing a cord of the corded window shade to pass axially into an interior cavity of the spool; and a second aperture for allowing the cord to exit the interior cavity of the spool; and a retaining component for affixing an end of the cord to a component of the window shade other than the spool.

A second aspect of the invention includes a window shade assembly including: a corded window shade; a rail coupled to the corded window shade, the rail including a rail-opening; a cord positioned through the corded window shade and the rail-opening of the rail; and a rail anchor assembly coupled to the rail, the rail anchor assembly including: a spool including a first aperture for allowing the cord to pass axially into an interior cavity of the spool; and a second aperture for allowing the cord to exit the interior cavity of the spool; and a retaining component for affixing an end of the cord to a component of the window shade other than the spool.

A third aspect of the invention includes a method for securing a cord to a rail of a window shade assembly, the method including: threading the cord axially into an interior cavity of a spool through a first aperture of the spool; threading the cord through a second aperture of the spool; and affixing an end of the cord to a component of the window shade other than the spool.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIGS. 1 and 2 show an inverted perspective view of a bottom portion of a window shade assembly, according to embodiments of the invention.

FIG. 3 shows an exploded perspective view of a window shade anchor assembly including a cord of a window shade assembly, according to embodiments of the invention.

FIG. 4 shows an assembled perspective view of a window shade anchor assembly including a cord of a window shade assembly, according to embodiments of the invention.

FIG. 5 shows a front view of a window shade anchor assembly including a cord of a window shade assembly, according to embodiments of the invention.

FIGS. 6-8 show a front view of a spool of a window shade anchor assembly, according to various alternative embodiments of the invention.

FIGS. 9-15 show a perspective view of a rail anchor assembly undergoing a method for securing a cord within a rail of a window shade assembly, according to embodiments of the invention.

FIGS. 16 and 17 show a front cross sectional view of a portion of a rail of a window shade assembly including a rail anchor assembly and a cord undergoing a process, according to embodiments of the invention.

FIG. 18 shows an inverted perspective view of a bottom portion of a window shade assembly, according to alternative embodiments of the invention.

FIG. 19 shows an exploded perspective view of a window shade anchor assembly including a cord of a window shade assembly, according to alternative embodiments of the invention.

FIG. 20 shows a bottom perspective view of a housing of a window shade anchor assembly, according to alternative embodiments of the invention.

FIG. 21 shows a front view of a window shade anchor assembly, according to alternative embodiments of the invention.

It is noted that the drawings of the invention are not necessarily to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As discussed herein, aspects of the invention relate generally to window shades and assemblies for use therein. More particularly, as discussed herein, aspects of the invention relate to a rail anchor assembly for a corded window shade assembly. As used herein, the term “window” may include any opening in a structure of any kind.

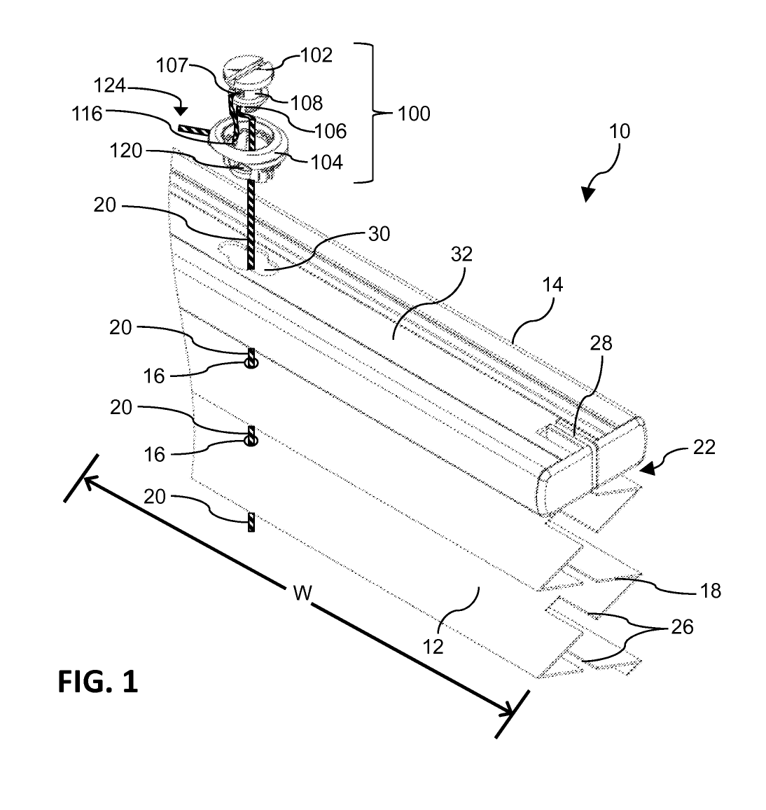

Turning to FIG. 1, an inverted perspective view of a bottom portion of a window shade assembly 10 is shown according to embodiments of the invention. Window shade assembly 10, as shown in FIG. 1, may include a corded window shade 12, and a bottom rail 14 coupled to corded window shade 12. Although embodiments of the present disclosure are described by example herein as being used with bottom rail 14, it is understood that other rails or components of window shade assembly 10 can be used in substitution. In an embodiment, as shown in FIG. 1, corded window shade 12 includes a plurality of holes 16 positioned through corded window shade 12. More specifically, the plurality of holes 16 may be positioned through corded window shade 12 approximate a side 18 of corded window shade 12. As shown in FIG. 1, the plurality of holes 16 may receive a cord 20 of window shade assembly 10. That is, cord 20 of window shade assembly 10 may be threaded through the plurality of holes 16 of corded window shade 12. As discussed herein, cord 20 threaded through the plurality of holes 16 of corded window shade 12 may aid in equalizing a horizontal position of bottom rail 14 and/or adjust the length of window shade 12 of window shade assembly 10. Although single cord 20 is shown being threaded through a plurality of holes 16 of window shade 12, it is understood that window shade 12 may include more than one set of the plurality of holes 16 of corded window shade 12. As such, where there are more than one set of the plurality of holes 16 within window shade 12, a plurality of cords 20 may be included in window shade assembly 10, wherein a single cord 20 is positioned in each of the sets of the plurality of holes 16.

As shown in FIG. 1, corded window shade 12 may be made from a conventional fabric window shade capable of substantially blocking light being emitted through a window opening utilizing window shade assembly 10. Additionally, as shown in FIG. 1, corded window shade 12 may be formed as a conventional, single-component accordion-style window shade. However, it is understood that corded window shade 12 may be made from any conventional material including, but not limited to: plastic, wood, wood-alloy, etc. Furthermore, it is understood that corded window shade 12 may be formed as any conventional window shade style including, but not limited to: cellular shades, pleated shades, sheer horizontal shades, roman shades, etc.

In an embodiment, as shown in FIG. 1, bottom rail 14 of window shade assembly 10 may be coupled to corded window shade 12. More specifically, bottom rail 14 may be coupled to an end 22 of corded window shade 12 along the entire width (W) of corded window shade 12. Bottom rail 14 may be coupled to end 22 of corded window shade 12 by any conventional coupling technique including, but not limited to: adhesives, ties, snap-fits, etc. Additionally, as shown in FIG. 1, corded window shade 12 may be positioned and may remain within a window frame (not shown) via a plurality of slots 26. More specifically, the plurality of slots 26 positioned in side 18 of corded window shade 12 may form a channel for receiving a guide component (not shown) of a window frame. The guide component positioned within the plurality of slots 26 may prevent corded window shade 12 from being undesirably removed from the window frame (not shown) and/or may guide corded window shade 12 as it moves within the window frame.

As shown in FIG. 1, bottom rail 14 may also include a rail opening 30. More specifically, bottom rail 14 may include a rail opening 30 positioned through a recessed surface 32 of bottom rail 14, where rail opening 30 is in substantial alignment with holes 16 positioned through corded window shade 12. In an embodiment, as shown in FIG. 1, cord 20 may be positioned through rail opening 30 of bottom rail 14 of window shade assembly 10. That is, cord 20 may be threaded through holes 16 of corded window shade 12 and rail opening 30 of bottom rail 14 of window shade assembly 10.

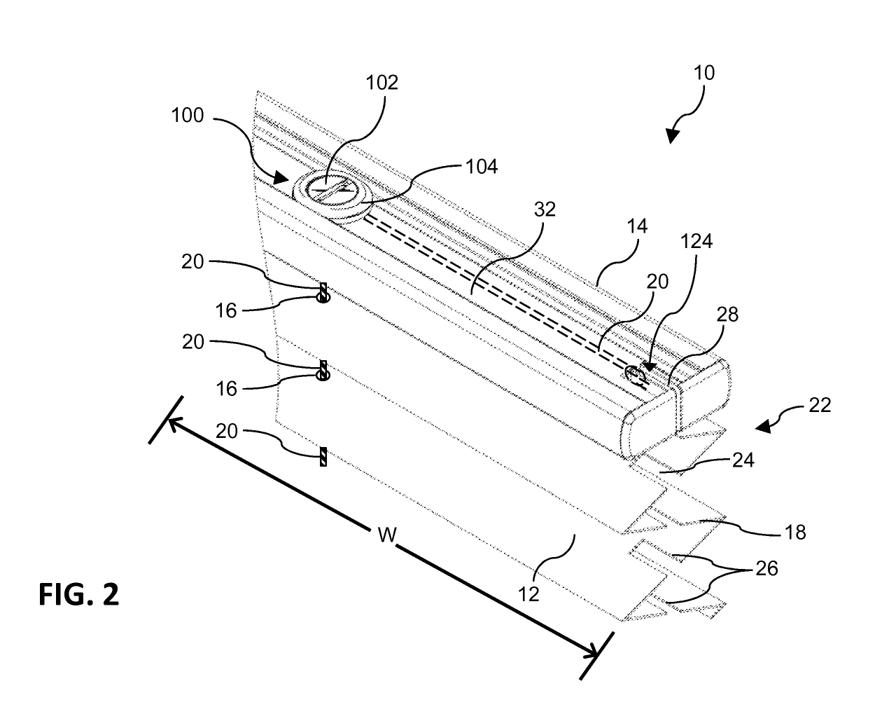

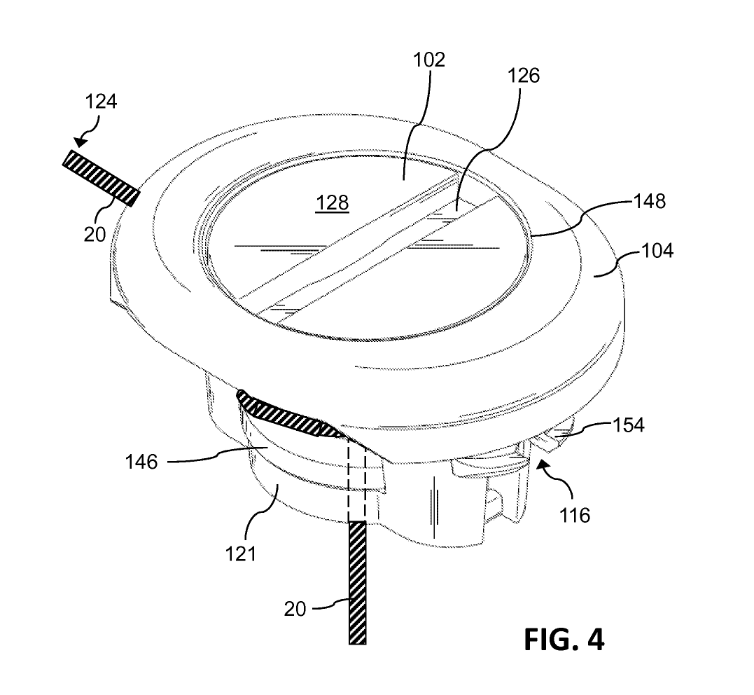

As shown in FIG. 1, window shade assembly 10 may also include a rail anchor assembly 100 (“anchor assembly”). As discussed herein, anchor assembly 100 may be utilized by window shade assembly 10 to secure cord 20 within bottom rail 14 of window shade assembly 10, aid in equalizing a horizontal position of bottom rail 14, and/or adjust the length of window shade 12 of window shade assembly 10. As shown in FIG. 1, anchor assembly 100 may include a spool 102 and optionally a housing 104 for receiving spool 102 (shown assembled in FIGS. 2 and 4). That is, as discussed herein, during the utilization of anchor assembly 100, spool 102 may be positioned within bottom rail 14 and/or within housing 104. Spool 102 can alternatively be positioned in other areas of window shade assembly 10 in other embodiments. Although a single anchor assembly 100 is shown in FIG. 1, it is understood that window shade assembly 10 may include a plurality of anchor assemblies 100 positioned within bottom rail 14. That is, and as discussed herein, where window shade assembly 10 includes a plurality of cords 20, window shade assembly 10 may include an equal number of anchor assemblies 100 for securing each of the plurality of cords 20 within bottom rail 14 of window shade assembly 10.

Briefly turning to FIG. 2, anchor assembly 100 may be positioned within bottom rail 14. More specifically, housing 104, and spool 102 positioned within housing 104, may be positioned within rail opening 30 formed through a surface 32 of bottom rail 14. As shown in FIG. 2, surface 32 is recessed, but this is not necessary in all cases. As shown in FIG. 2, where surface 32 is recessed, anchor assembly 100 may be positioned within recessed surface 32 of bottom rail 14 such that anchor assembly 100 may not be substantially visible during operation or use of window shade assembly 10. In an alternative embodiment, not shown, where bottom rail 14 includes a substantially uniform surface (e.g., no recessed surface 32), anchor assembly 100 may be positioned within rail opening 30 (FIG. 1) of bottom rail 14 and may be substantially flush with the uniform surface of bottom rail 14. That is, in an alternative embodiment, where bottom rail 14 does not include recessed surface 32, anchor assembly 100 may be substantially co-planar with uniform surface of bottom rail 14 including rail opening 30 (FIG. 1).

Additionally, as shown in FIG. 2, cord 20 (shown in phantom) of anchor assembly 100 may pass through and/or within bottom rail 14. More specifically, as shown in FIG. 2, after passing through spool 102 and housing 104 of anchor assembly 100, cord 20 (shown in phantom) may pass within and along a portion of the width (W) of bottom rail 14 toward end 22 of corded window shade 12. End 124 of cord 20 may be knotted and may be substantially secured within slot 28 of bottom rail 14. Although slot 28 is shown to substantially secure end 124 of cord 20, it is understood that any retaining component (e.g., a fastener, an adhesive substance, and/or any other currently known or later developed mechanism for coupling two components) can secure end 124 of cord 20. It is further understood that retaining components such as slot 28 can be provided in other locations if desired.

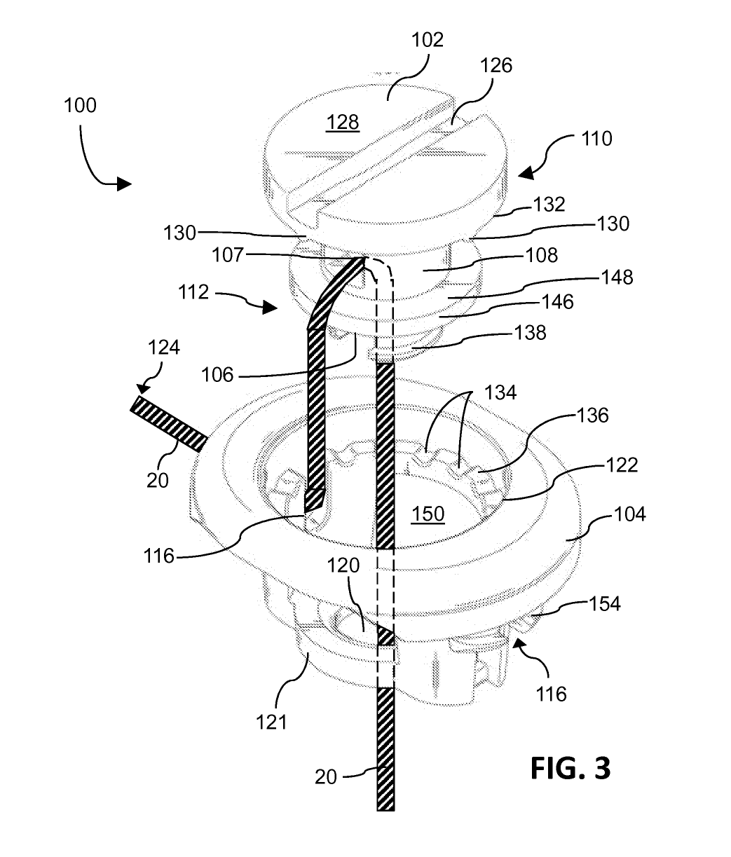

Returning to FIG. 1, and with reference to FIG. 3, spool 102 may include a first aperture 106 for allowing cord 20 of corded window shade 12 to pass through an interior cavity of spool 102. More specifically, as shown in FIG. 1 and FIG. 3, spool 102 may include first aperture 106 extending axially (i.e., substantially along or parallel to an axis of rotation of spool 102) through a body 108 of spool 102, wherein cord 20 may pass through first aperture 106 to aid in securing cord 20 to another component of window shade assembly 10, equalizing a horizontal position of bottom rail 14 and/or adjust the length of window shade 12 of window shade assembly 10, as discussed herein. As discussed elsewhere herein, spool 102 can also include a second aperture 107 through which cord 20 can pass, allowing cord 20 to exit first aperture 106 and/or the interior cavity of spool 102. As shown in FIG. 3, first aperture 106 positioned through body 108 may also be positioned between a first end 110 and second end 112, positioned opposite first end 110, of spool 102. More specifically, as shown in FIG. 3, first aperture 106 may extend through second end 112 of spool 102 and into body 108 of spool 102, and may be substantially perpendicular to second aperture 107 of spool 102. As discussed herein, first aperture 106 and the interior cavity of spool 102 may form a passageway for cord 20 to pass through spool 102, where anchor assembly 100 is utilized within window shade assembly 10 (FIGS. 1 and 2).

Additionally, as shown in FIGS. 1 and 3, spool 102 of window shade assembly 10 can optionally be positioned within housing 104. More specifically, as shown in FIGS. 1 and 3, housing 104 may include a first opening 120 through a base portion 121, a second opening 122 positioned opposite first opening 120, and a plurality of apertures 116 positioned through housing 104 opposite one another. As shown in FIGS. 1 and 3, and discussed herein, cord 20 may pass through a first opening 120 and second opening 122 of housing 104 to first aperture 106 of spool 102, and may also pass through second aperture 107 of spool 102, back through second opening 122 of housing 104 and then to an aperture 116 of housing 104. As discussed herein, cord 20 may pass through aperture 116, and an end 124 of cord 20 may be secured to housing 104, bottom rail 14, and/or window shade assembly 10 after passing through aperture 116.

In an embodiment, as shown in FIG. 3, spool 102 may also include a tool engagement element 126 positioned at a first end 110 of spool 102. More specifically, spool 102 may include tool engagement element 126 positioned on a first surface 128 of first end 110 of spool 102. As discussed herein, tool engagement element 126 of spool 102 may receive a tool (not shown) for rotating spool 102. In one example, as shown in FIG. 3, tool engagement element 126 of spool 102 may be formed as a single slit for receiving a substantially flat tool (not shown), such as a flat head screwdriver, used to rotate spool 102 within housing 104, where anchor assembly 100 is utilized within window shade assembly 10 (FIGS. 1 and 2). However, it is understood that tool engagement element 126 of spool 102 may be formed as any conventional shape capable of receiving a tool for rotating spool 102 including, but not limited to: a Philips socket, a square socket, hex socket, torx socket, etc. In addition or alternatively, tool engagement element 126 can be manually rotatable by a user without a tool, as for example, by user's fingernail in slit shown as 126 in FIG. 3. Briefly turning to FIG. 4, first surface 128 including tool engagement element 126 may be substantially exposed when spool 102 may be substantially positioned within housing 104. As discussed herein, by allowing tool engagement element 126 to be substantially exposed while spool 102 is positioned within housing 104, a user (e.g., window shade owner) may manipulate or engage a tool (not shown) with tool engagement element 126 to rotate spool 102 within housing 104 for equalizing a horizontal position of bottom rail 14 and/or adjusting the length of window shade 12 of window shade assembly 10, e.g., by winding or unwinding cord 20 about spool 102 while end 124 and other components of window shade assembly 10 (e.g., housing 104) remain in place.

Returning to FIG. 3, first end 110 of spool 102 may also include an engagement structure 130. More specifically, spool 102 may include a plurality of engagement structures 130 positioned on a second surface 132 of first end 110, opposite to first surface 128. As shown in FIG. 3, engagement structure 130 may also be positioned at first end 110 of spool 102, opposite tool engagement element 126. Engagement structures 130, as shown in FIG. 3, may be formed as protrusions or ridges formed on second surface 132 of first end 110 of spool 102. In an embodiment, as shown in FIG. 3, engagement structure 130 of spool 102 may be shaped to contact a plurality of grooves 134 formed in housing 104. More specifically, as shown in FIG. 3, housing 104 may include an internal contact surface 136 having the plurality of grooves 134 for receiving engagement structure 130 of spool 102. As discussed herein, the plurality of grooves 134 of housing 104 may receive engagement structure 130 of spool 102 to substantially secure spool 102 in a user-selected rotational position within housing 104. As shown in FIG. 4, engagement structure 130 of spool 102 and contact surface 136 including plurality of grooves 134 of housing 104 may be substantially hidden or not exposed when spool 102 is positioned within housing 104.

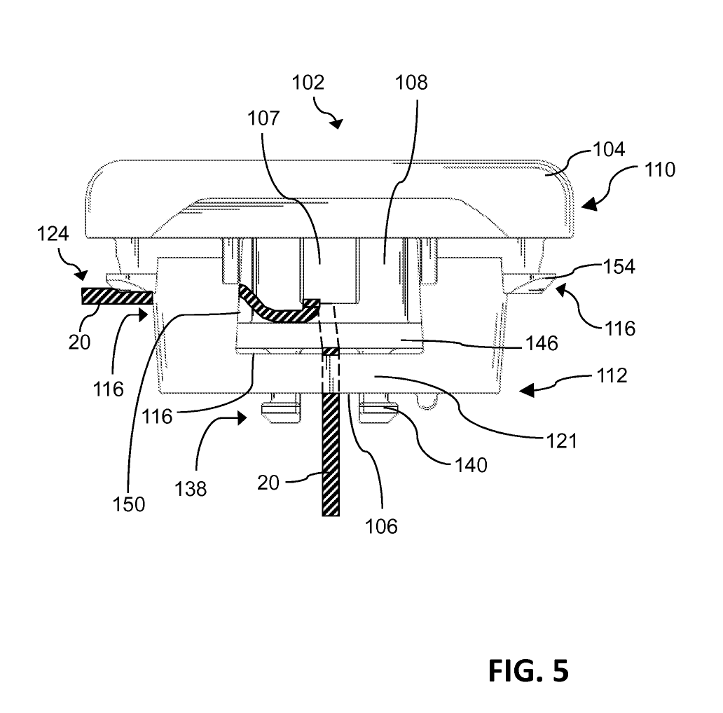

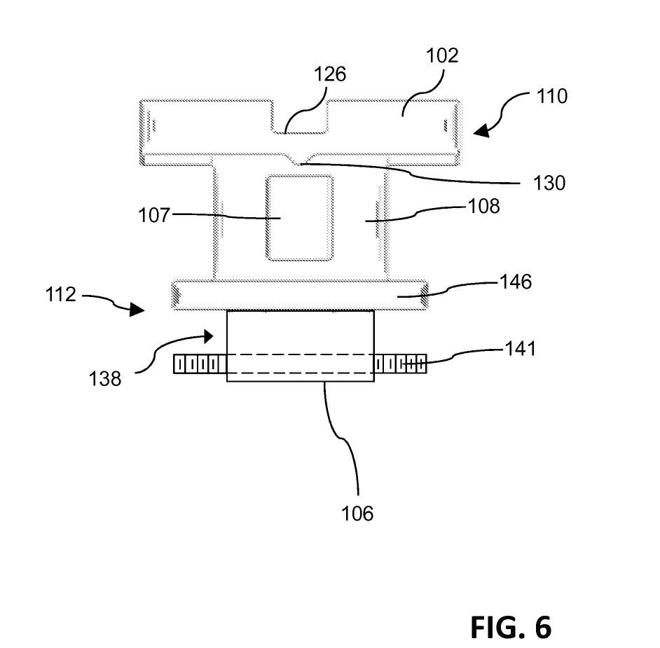

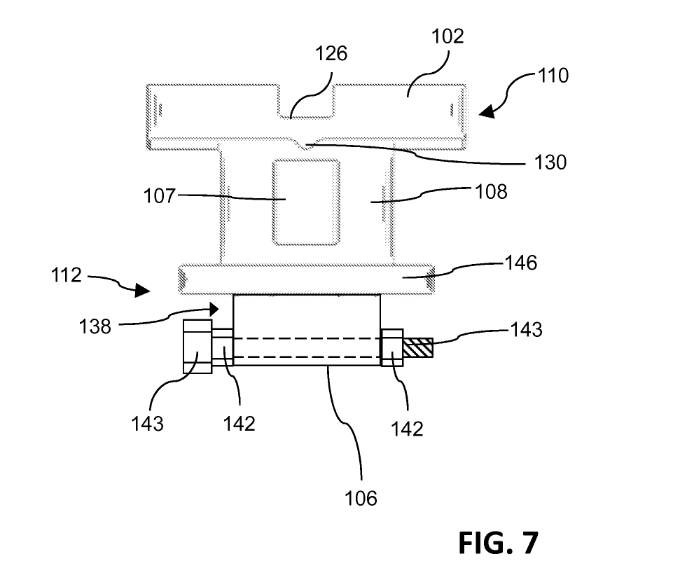

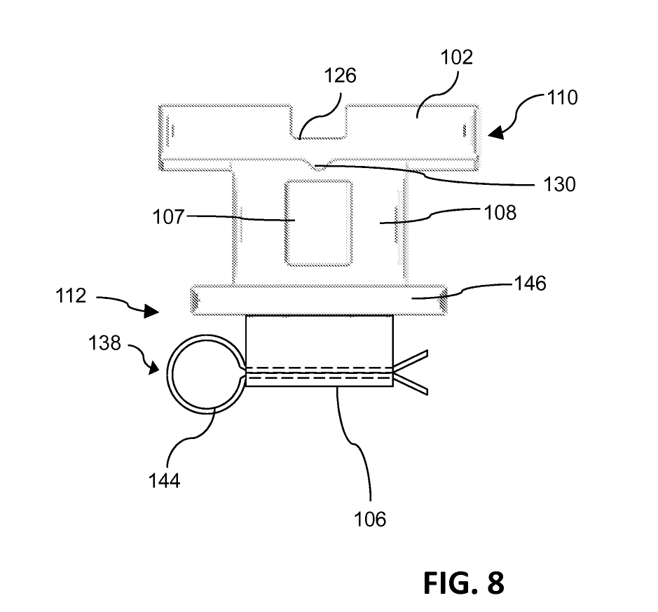

As shown in FIG. 3, and with reference to FIG. 5, spool 102 may also include a coupling structure 138 positioned at second end 112 of spool 102, opposite first end 110. As shown in FIG. 5, coupling structure 138 of spool 102 may couple spool 102 to housing 104. More specifically, coupling structure 138 may be formed to couple spool 102 within housing 104 during the utilization of anchor assembly 100 within window shade assembly 10 (FIG. 1). As shown in FIGS. 3 and 5, coupling structure 138 of spool 102 may pass through first opening 120 (FIG. 3) of housing 104 for coupling spool 102 to housing 104. That is, as shown in FIG. 5, coupling structure 138 may include snap-fit portions 140 that may pass through first opening 120 and may be positioned below base portion 121 of housing 104 to couple spool 102 to housing 104. Spool 102 may be substantially secured within housing 104 and/or may not be removed from housing 104 as a result of snap-fit portions 140 of coupling structure 138 having a diameter larger than a diameter of first opening 120 of housing 104. However, spool 102 may selectively rotate relative to housing 104 against the restriction of engagement structure 130 and grooves 134. As such, during the insertion of spool 102 into housing 104, coupling structure 138 may be substantially flexible to allow snap-fit portions 140 to pass through first opening 120 of housing 104. Although discussed herein as including snap-fit portions 140, coupling structure 138 may include any fastener that secures spool 102 to housing 104, yet also allows rotation of spool 102 relative to housing 104. More specifically, and as shown in FIGS. 6-8, coupling structure 138 may be selected from a group consisting of: a threaded fastener 141 (FIG. 6), a nut 142 and bolt 143 assembly (FIG. 7) and a cotter pin 144 (FIG. 8).

As shown in FIGS. 3 and 5, spool 102 may also include a flange 146 positioned at second end 112 of spool 102. More specifically, as shown in FIGS. 3 and 5, spool 102 may include flange 146 positioned between body 108 of spool 102 and coupling structure 138 of spool 102. As shown in FIG. 5, where spool 102 is positioned within housing 104, flange 146 of second end 112 of spool 102 may contact and be positioned adjacent base portion 121 of housing 104. More specifically, flange 146 of spool 102 may contact base portion 121 of housing 104 to substantially prevent body 108 of spool 102 from being positioned below base portion 121 of housing 104. As discussed herein, flange 146 also forms a barrier for cord 20 that may be wrapped around body 108 of spool 102 during operation of anchor assembly 100, such that the flange 146 may prevent cord 20 from being undesirably positioned within first opening 120 of housing 104 and/or below base portion 121 of housing 104. As discussed herein, flange 146 may provide a portion 148 of spool 102 which may receive a user-selected amount of cord 20 rotatably stowed around body 108 and/or on flange 146.

Also shown in FIGS. 3 and 5, housing 104 may also include an area 150 adjacent body 108 and portion 148 of spool 102. More specifically, housing 104 may include a plurality of areas 150 positioned opposite one another and on either side of spool 102. As shown in FIG. 3, area 150 may be positioned substantially between contact surface 136 and base portion 121 of housing 104. As discussed herein, area 150 may be shaped for receiving an excess portion of a user-selected amount of cord 20 circumferentially positioned around body 108 and/or portion 148 of spool 102 during the utilization of anchor assembly 100 within window shade assembly 10.

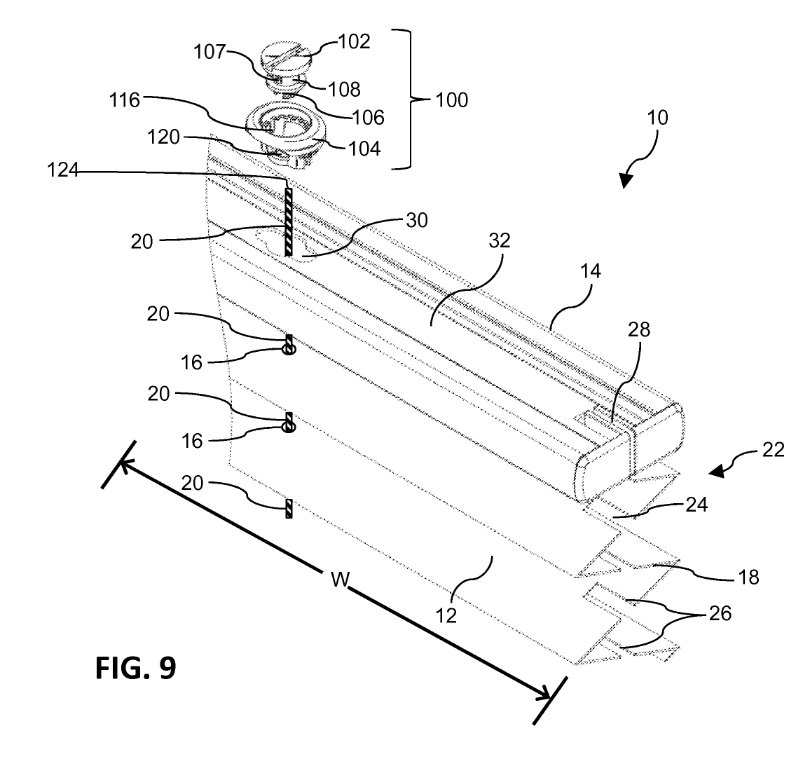

Various additional embodiments of the invention can include a method for securing cord 20 to a fixed component (e.g., within bottom rail 14) of window shade assembly 10. Turning to FIGS. 9-15, a perspective view of bottom rail anchor assembly 100 undergoing a method for securing cord 20 to a component of window shade assembly 10 according to embodiments of the invention is shown. Examples of the method discussed herein refer to securing cord 20 within bottom rail 14, though it is understood that cord 20 can be secured to other components of window shade assembly other than spool 102 if desired. As shown in FIGS. 9-15, one illustrative method according to various embodiments can include the following processes:

In FIG. 9, cord 20 is threaded through window shade 12 and bottom rail 14, respectively. As shown in FIG. 9, cord 20 may be threaded through each of the plurality of holes 16 of window shade 12 and rail opening 30 of bottom rail 14, such that an end 124 of cord 20 may be positioned substantially outside of rail opening 30 of bottom rail 14. In an embodiment, as shown in FIG. 9, end 124 of cord 20 may be positioned substantially outside of bottom rail 14 and may be in alignment with anchor assembly 100. As shown in FIG. 9, cord 20 may be threaded through shade 12 and bottom rail 14 by any conventional technique. That is, cord 20 may first be threaded through the plurality of holes 16 of window shade 12 and subsequently threaded through rail opening 30 of bottom rail 14. Alternatively, cord 20 may be first be threaded through rail opening 30 of bottom rail 14, and subsequently threaded through the plurality of holes 16 of window shade 12.

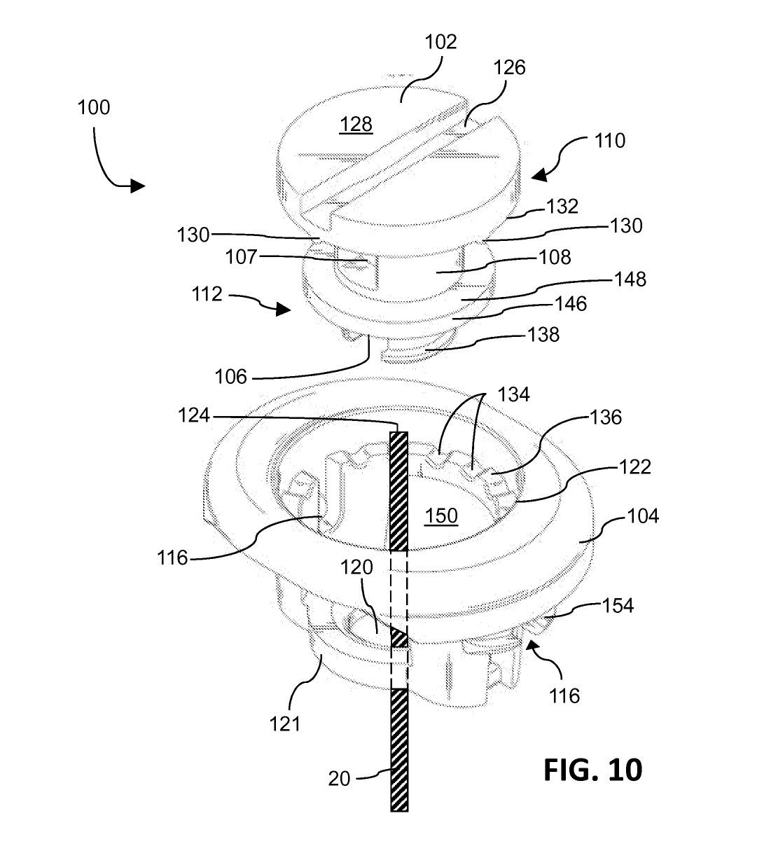

In FIG. 10, following the process shown in FIG. 9, cord 20 is shown being threaded through first opening 120 of housing 104. More specifically, as shown in FIG. 10, end 124 of cord 20 may be threaded through first opening 120 of housing 104 and second opening 122 of housing 104, positioned opposite first opening 120 of housing 104. That is, end 124 of cord 20 may be threaded completely through a substantially vertical passageway formed in housing 104 by first opening 120 and second opening 122.

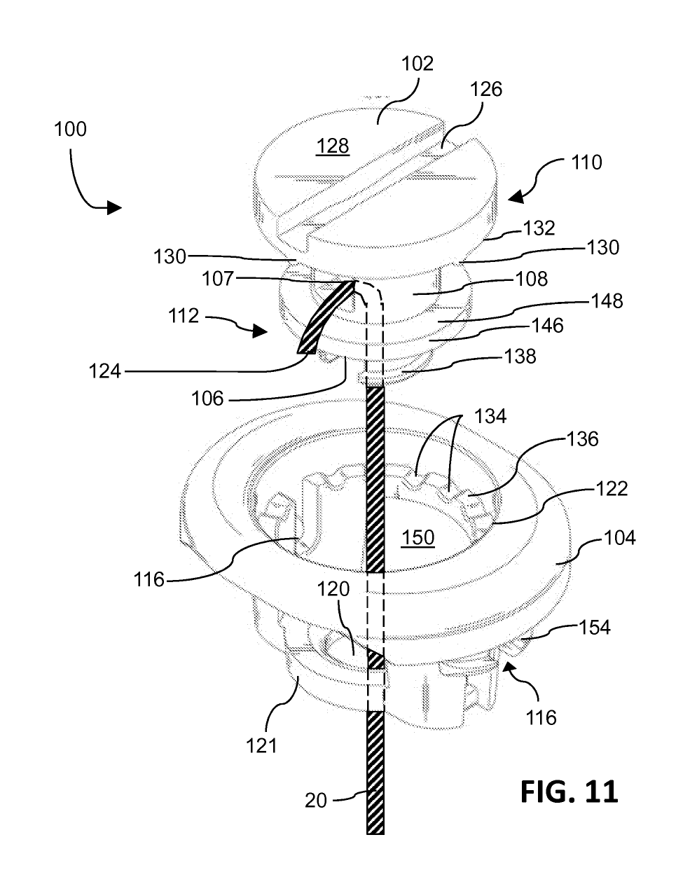

In FIG. 11, cord 20 is shown being threaded through first and second apertures 106, 107 of spool 102 of anchor assembly 100. As shown in FIG. 11, end 124 of cord 20 may pass from the vertical passageway formed by first opening 120 and second opening 122 of housing 104, and may be threaded through first aperture 106 of spool 102 to pass through an interior cavity therein. More specifically, end 124 of cord 20 may pass axially through first aperture 106 extending substantially through a portion of spool 102, and end 124 may also be removed from spool 102 by passing through second aperture 107 of spool 102. Second aperture can be positioned radially (i.e., substantially perpendicular to the axis of rotation of spool 102) with respect to spool 102, or can have any other desired orientation. As discussed herein, first aperture 106 and second aperture 107 of spool 102 may be formed substantially perpendicular to one another. That is, as shown in FIG. 11, second aperture 107 may be formed proximate to second end 112 of spool 102 and may be formed substantially concentric to body 108 of spool 102, and first aperture 106 may extend axially through a portion of body 108 of spool 102 (i.e., forming an interior cavity therein) to form a passageway for cord 20 through spool 102.

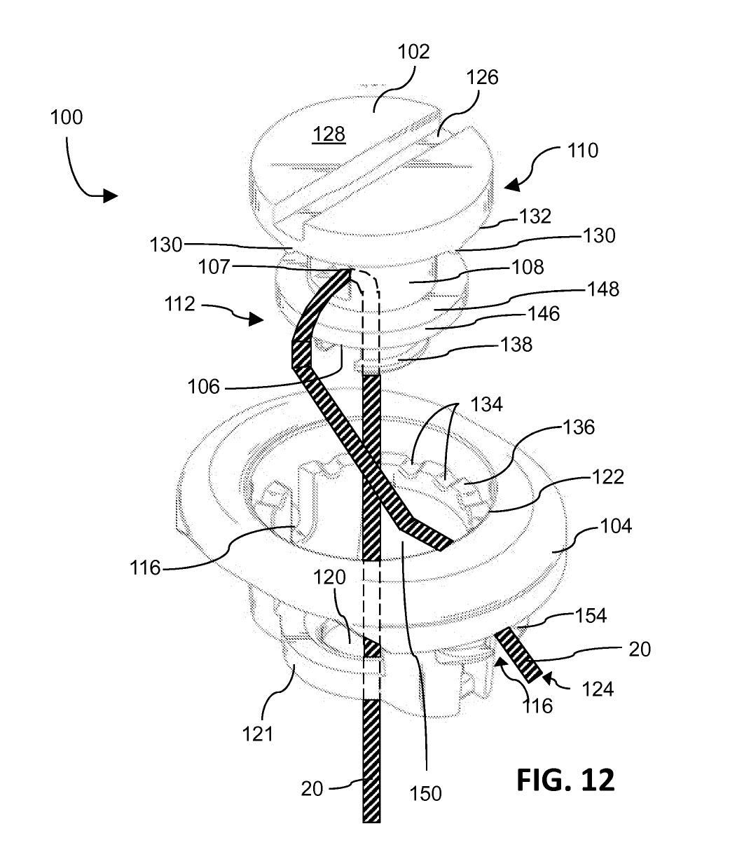

In FIG. 12, following the process shown in FIG. 11, cord 20 is shown being threaded through aperture 116 of housing 104 of anchor assembly 100. More specifically, as shown in FIG. 12, cord 20 may be threaded through aperture 116 of housing 104 to position end 124 of cord 20 outside of housing 104. In comparing FIGS. 3 and 12, it is understood that cord 20 may be threaded through any of the plurality of apertures 116 of housing 104.

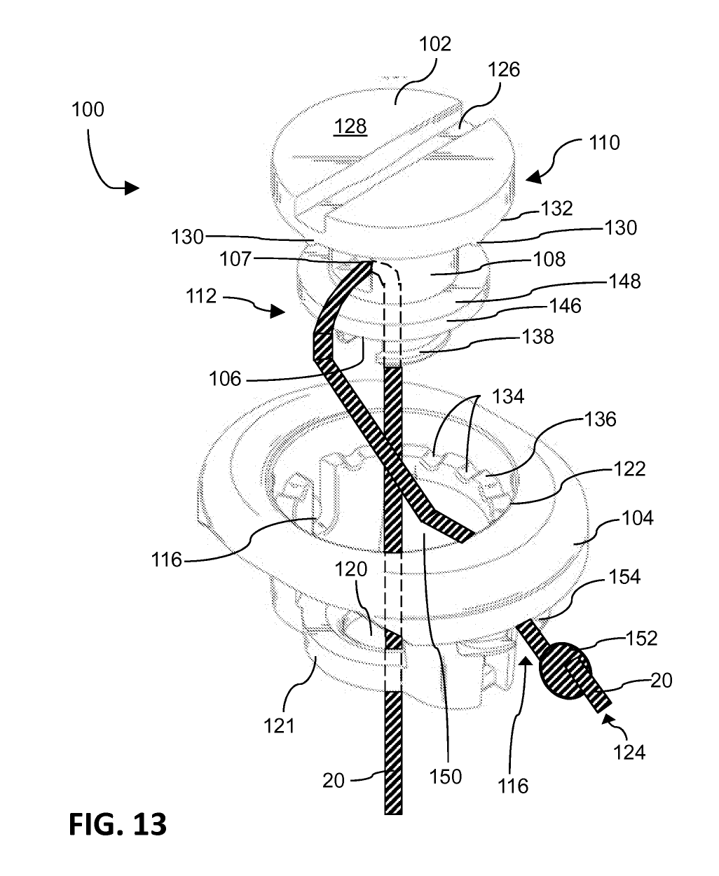

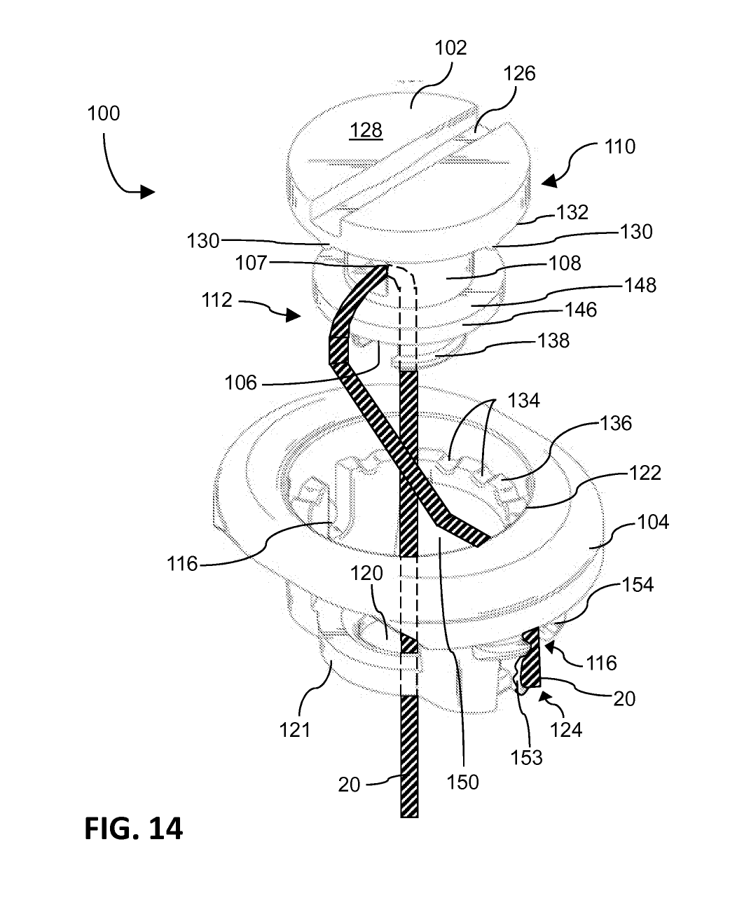

In an embodiment and as shown by example in FIG. 13, end 124 of cord 20 can be secured to, so as to prevent removal from, a component of window shade assembly 10 other than spool 102, such as housing 104 of anchor assembly 100. In an example embodiment, end 124 of cord 20 may positioned outside of and secured to housing 104 to substantially prevent end 124 of cord 20 from being positioned inside of housing 104. As shown in FIGS. 13 and 14, end 124 of cord 20 may be secured to housing 104 to substantially prevent end 124 from becoming unthreaded from aperture 116 of housing 104 during the utilization of anchor assembly 100 within window shade assembly 10. Additionally, end 124 of cord 20 may be secured to housing 104 to substantially prevent end 124 from reentering a vertical passageway formed in housing 104 by first opening 120 and second opening 122, and subsequently being unthreaded from spool 102 and/or first opening 120 and second opening 122 of housing 104. As discussed herein, end 124 of cord 20 may be secured to housing 104 in order for anchor assembly 100 to aid in equalizing a horizontal position of bottom rail 14 and/or adjust a length of window shade 12 of window shade assembly 10. As shown in FIG. 13, the securing of end 124 of cord 20 to housing 104 may include positioning end 124 of cord 20 including a knot 152 outside of housing 104 of anchor assembly 100. More specifically, end 124 of cord 20 may be secured to housing 104 by positioning end 124 outside of housing 104, and subsequently tying knot 152 in end 124 of cord 20. As shown in FIG. 13, knot 152 may be larger than aperture 116 of housing 104 for preventing end 124 of cord 20 from being positioned inside of housing 104. End 124 of cord 20 may be secured to housing 104 and may not be positioned inside of housing 104 once knot 152 is formed in end 124. Alternatively, end 124 of cord 20 may be positioned outside of and secured to housing 104 by any conventional coupling technique. More specifically, in an alternative embodiment as shown in FIG. 14, end 124 of cord 20 may be secured to housing 104 by coupling end 124 of cord 20 to housing 104 using an adhesive 153. It is also understood that end 124 of cord 20 may be secured to housing 104 by other conventional coupling techniques including, but not limited to: tape, clamps, ties, etc. In addition or alternatively, cord 20 can be secured to other locations or components in a similar fashion. For example, cord 20 can be secured to components of corded window shade 12, bottom rail 14, slot 28, and/or other non-rotating parts of window shade 12.

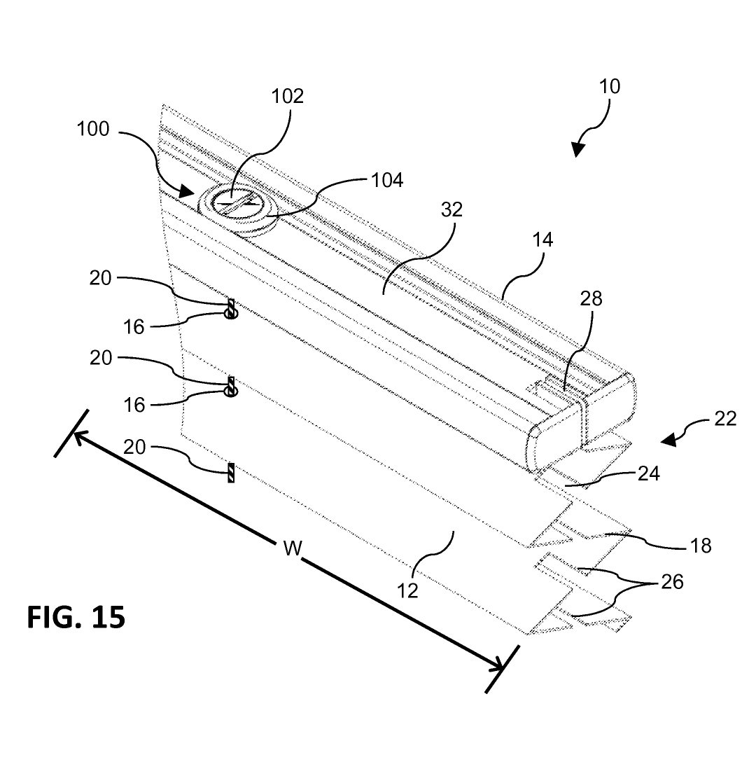

In an embodiment shown in FIG. 15 and discussed herein, anchor assembly 100 can be coupled to bottom rail 14 to secure cord 20 within bottom rail 14 of window shade assembly 10. More specifically, as shown in FIG. 15, with reference to FIG. 13, housing 104 and spool 102, positioned within housing 104, may be positioned within bottom rail 14 to secure cord 20 within bottom rail 14, and substantially prevent cord 20 from being removed from bottom rail 14. In an embodiment, as shown in FIG. 15, housing 104 of anchor assembly 100 may be positioned within rail opening 30 of bottom rail 14 for coupling anchor assembly 100 to bottom rail 14. More specifically, as shown in FIG. 15 and with reference to FIGS. 5 and 13, housing 104 may include a plurality of protrusions 154 positioned opposite one another and adjacent aperture 116 of housing 104 (FIG. 13) for coupling housing 104 to bottom rail 14. More specifically, upon insertion of housing 104 within rail opening 30 of bottom rail 14, protrusions 154 of housing 104 (FIG. 13) may engage the structural edges of rail opening 30 (e.g., FIG. 9) to substantially couple housing 104 of anchor assembly 100 to bottom rail 14. By inserting housing 104 within rail opening 30 and allowing protrusions 154 to engage the structural edges of rail opening 30, housing 104, and subsequently anchor assembly 100, may be coupled to and may be prevented from being removed from bottom rail 14 of window shade assembly 10. Although protrusions 152 may be used for coupling anchor assembly 100 within bottom rail 14, alternative mechanisms may also be used including, but not limited to: friction fit, adhesives, etc.

As shown in FIG. 15, spool 102 may be positioned within housing 104 when coupling anchor assembly 100 to bottom rail 14 of window shade assembly 10. As discussed herein, after securing end 124 of cord 20 to housing 104 in FIG. 13, spool 102 may be positioned within and coupled to housing 104 prior to coupling anchor assembly 100, and specifically housing 104, to bottom rail 14. That is, after the process shown in FIG. 13, but prior to the process shown in FIG. 15, an intermediate process may include coupling spool 102 to housing 104 via coupling structure 138, as discussed herein. In an alternative embodiment, spool 102 may be coupled to housing 104 subsequent to housing 104 being coupled to bottom rail 14. More specifically, subsequent to the process shown in FIG. 13 and subsequent an intermediate process of coupling only housing 104 within rail opening 30 of bottom rail 14, spool 102 may be coupled to housing 104 positioned within bottom rail 14, to complete the process shown in FIG. 15. That is, spool 102 may be coupled to housing 104 via coupling structure 138 after housing 104 is coupled to bottom rail 14 of window shade assembly 10.

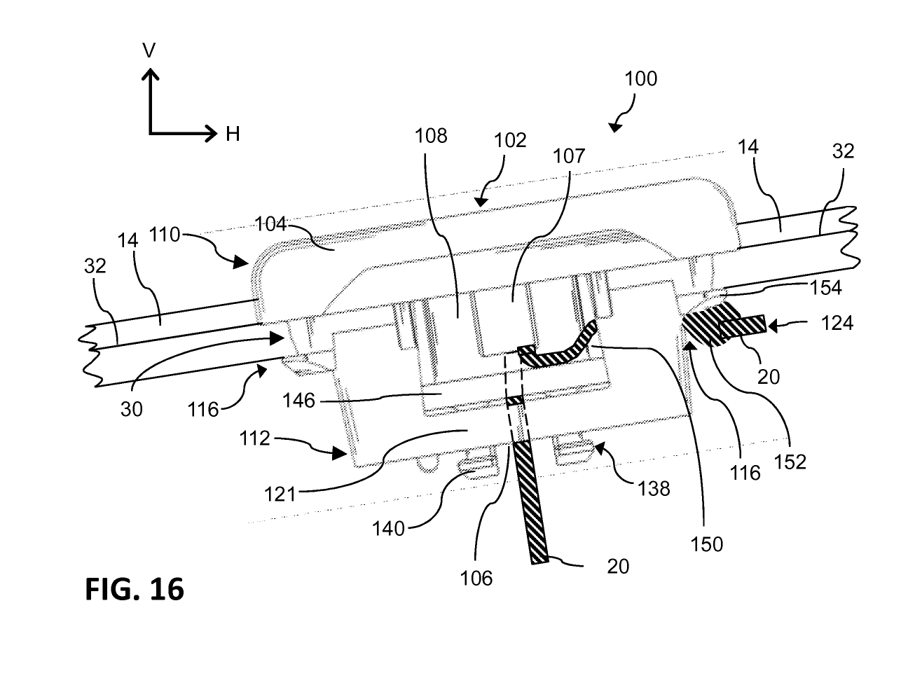

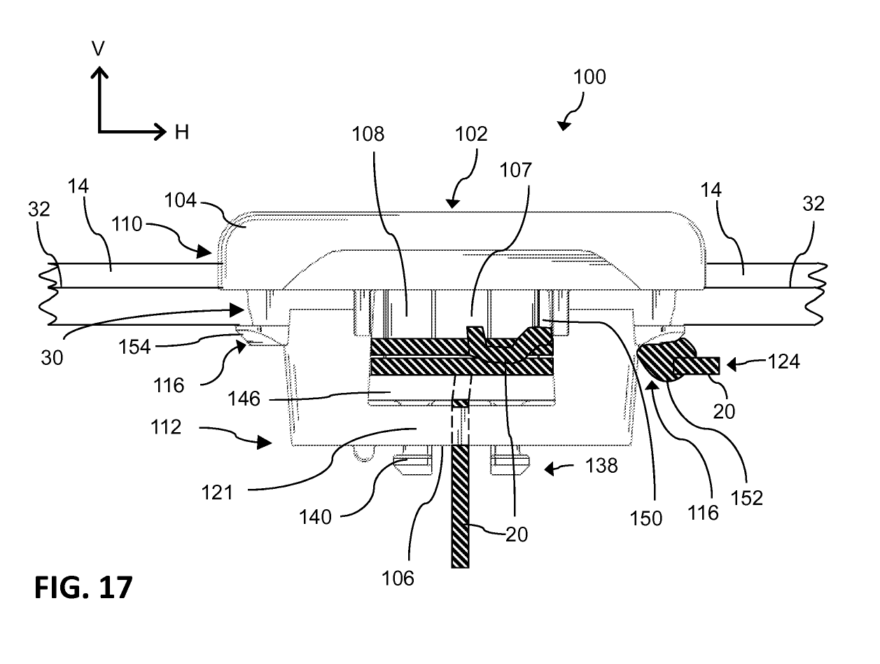

Once end 124 of cord 20 is secured to housing 104, and cord 20 is secured within bottom rail 14 of window shade assembly 10, a user (e.g., window shade owner) may utilize anchor assembly 100 to aid in equalizing a horizontal position of bottom rail 14 and/or adjusting an overall length of window shade 12. With reference to FIGS. 16 and 17, a process of equalizing a horizontal position of bottom rail 14 is discussed. Turning to FIG. 16, a portion of bottom rail 14 including anchor assembly 100 and cord 20 is shown oriented in a position (e.g., upside down) where anchor assembly 100 is being utilized in window shade assembly 10. As shown in FIG. 16, anchor assembly 100 may be positioned within bottom rail 14 of window shade assembly 10 (FIG. 15) for securing cord 20 within bottom rail 14. In an embodiment, as shown in FIG. 16, a completely assembled window shadow assembly 10 (FIG. 15) including anchor assembly 100 may be shown prior to adjusting anchor assembly 100 to equalize a horizontal position of bottom rail 14. More specifically, bottom rail 14 of window shade assembly 10 may not be in a desired horizontal position, and may be substantially misaligned with horizontal axis (H). As shown in FIG. 16, the portion of bottom rail 14 may be substantially sloped and positioned below a desired horizontal position (e.g., aligned with horizontal axis (H)).

As a result, a user (e.g., window shade owner) may utilize anchor assembly 100 to equalize the horizontal position of bottom rail 14 to be oriented in a desired horizontal position. More specifically, a user may utilize a tool (not shown) to be engaged with tool engagement element 126 (FIG. 14) in first end 110 of spool 102, to selectively rotate spool 102 within housing 104 of anchor assembly 100. As shown in FIG. 17, by rotating spool 102 within housing 104, a user-selected amount of cord 20 may be circumferentially positioned (e.g., wound or unwound) around body 108 of spool 102 and horizontal position of bottom rail 14 may be adjusted. More specifically, as shown in FIG. 17, a user may rotate spool 102 within housing 104 to a user-selected position of spool 102, in order for a user-selected amount of cord 20 to be positioned around body 108 to substantially decrease the length of cord 20 and/or adjust the position of bottom rail 14. As discussed elsewhere herein, one end 124 of cord 20 can through aperture 116 and be affixed to a component of window shade assembly 10 other than spool 102. The remainder of cord 20 can axially enter an interior cavity of spool 102 through first aperture 106, and exit spool 102 through second aperture 107. The axial entry of cord 20 to spool 102 through first aperture 106 can minimize or eliminate undesirable torque on spool 102. In other words, as is shown in FIG. 17, end 124 of cord 20 being affixed to a component other than spool 102 allows cord 20 to be wound or unwound about spool 102 without being offset or otherwise affected by axial tension in cord 20. This configuration can prevent spool 102 from changing position and/or releasing the user-selected amount of cord 20 from being wrapped around spool 102. As discussed herein, retaining the user-selected position of spool 102 can optionally be aided with housing 104, engagement structure 132 of spool 102, and the plurality of grooves 130 of housing 104 (FIG. 10). As shown in FIG. 17, by rotating spool 102, and subsequently circumferentially positioning a user-selected amount of cord 20 around body 108 of spool 102, length of cord 20 may substantially adjusted (e.g., shortened) and bottom rail 14 may be in substantial alignment with horizontal axis (H).

Also shown in FIG. 17, during the rotating of spool 102 and/or the circumferential positioning of a user-selected amount of cord 20 around body 108 of spool 102, cord 20 may overlap and/or build-up within anchor assembly 100. That is, as cord 20 is circumferentially positioned around body 108 of spool 102, the user-selected amount of cord 20 may not be positioned uniformly (e.g., side-by-side) around body 108, and the user-selected amount of cord 20 may include a non-uniform diameter. As shown in FIG. 17, area 150 of housing 104 may receive an excess portion of the user-selected amount of cord 20 circumferentially position around body 108 of spool 102. More specifically, when the user-selected amount of cord 20 may overlap and/or build-up and include a non-uniform diameter, area 150 of housing may receive the excess or overlapping portion of cord 20 to prevent cord 20 from becoming substantially lodged or stuck (e.g., spool 102 becomes non-rotatable) within anchor assembly 100.

In order to adjust an overall length of window shade 12, the process discussed with respect to FIGS. 16-17 may be performed on all anchor assemblies 100 included within bottom rail 14 of window shade assembly 10. That is, rather than equalizing a horizontal position of bottom rail 14 by adjusting a single anchor assembly 100, as discussed with reference to FIGS. 16-17, all anchor assemblies 100 may be adjusted to change or adjust an overall length of window shade 12. It is understood that the overall length of window shade 12 may be substantially shortened or lengthened as a result of adjusting anchor assembly 100, as discussed herein.

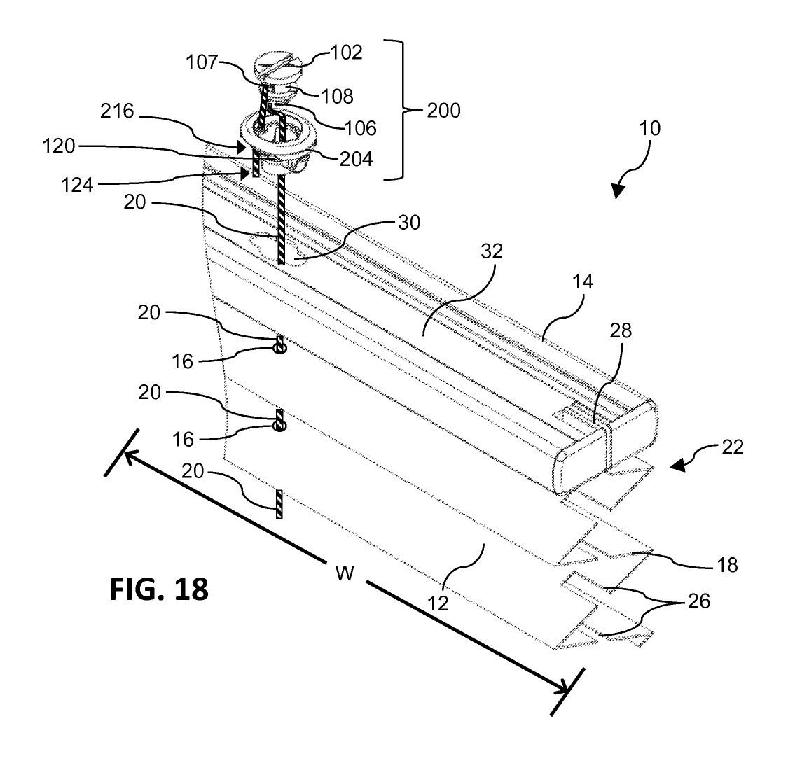

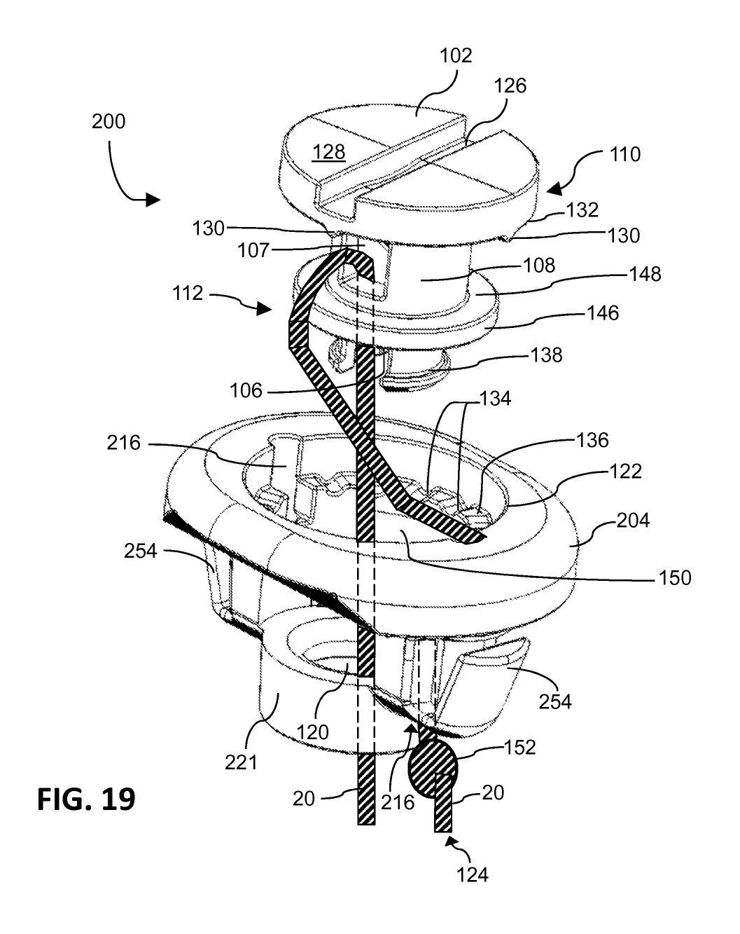

Turning to FIGS. 18-21, a window shade anchor assembly 200 including cord 20 of window shade assembly 10 (FIG. 18) is shown according to alternative embodiments of the invention. More specifically, as shown in FIGS. 18 and 19, anchor assembly 200 may include spool 102 and a housing 204 for receiving spool 102, as similarly discussed herein. In the Figures, it is understood that similarly numbered components may represent substantially similar components, which can function in a substantially similar manner. Redundant explanation of these components has been omitted for clarity.

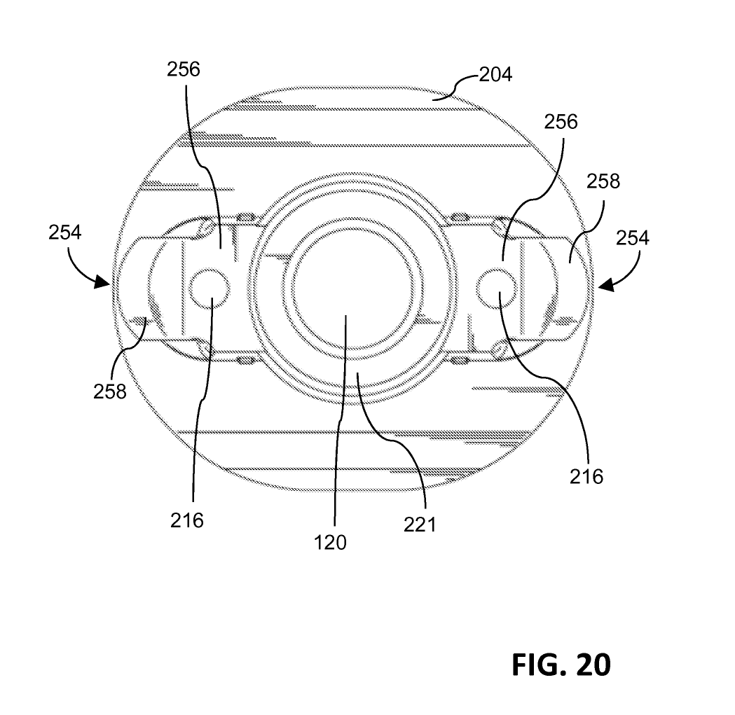

As shown in FIGS. 19 and 20, housing 204 may include aperture 216 through which cord 20 may pass. More specifically, as shown in FIGS. 19 and 20, housing 204 may include a plurality of apertures 216 which may allow cord 20 to pass through a selected aperture 216, to be positioned outside of and secured to housing 204, as discussed herein. Aperture 216 of housing 204 may include a substantially elongated vertical opening for cord 20 to pass through. That is, as shown in FIGS. 19 and 20, aperture 216 may be formed through housing 204 and may be positioned substantially parallel to second opening 122 of housing 204, such that portions of cord 20 may pass through second opening 122 and aperture 216 and be substantially parallel (e.g., vertical). As shown in FIGS. 19 and 20, aperture 216 may extend vertically through a portion of housing 204. In comparing FIGS. 3 and 19-20, it is understood that aperture 216 of anchor assembly 200 (FIGS. 19 and 20) may be formed substantially parallel to second opening 122 of housing 204, and aperture 116 of anchor assembly 100 (FIG. 3) may be formed substantially perpendicular to second opening 122 of housing 104. As a result of the position of aperture 216 of housing 204, as shown in FIG. 19, end 124 of cord 20 may be secured outside of housing 204 and may be positioned substantially below second opening 122 of housing 204. More specifically, as shown in FIG. 19, end 124 of cord 20 may be positioned outside of housing 204 and may be positioned substantially adjacent base portion 221 and/or may be positioned substantially below protrusions 254 of housing 204. Additionally, as shown in FIGS. 19-21, aperture 216 of housing 204 may be substantially enclosed within housing 204. More specifically, aperture 216 may extend through housing 204 substantially parallel with second opening 122, such that cord 20 passing through aperture 216 may be positioned inside an exterior surface of housing 204 (e.g., not exposed outside of housing 204) until end 124 of cord is positioned adjacent base portion 221.

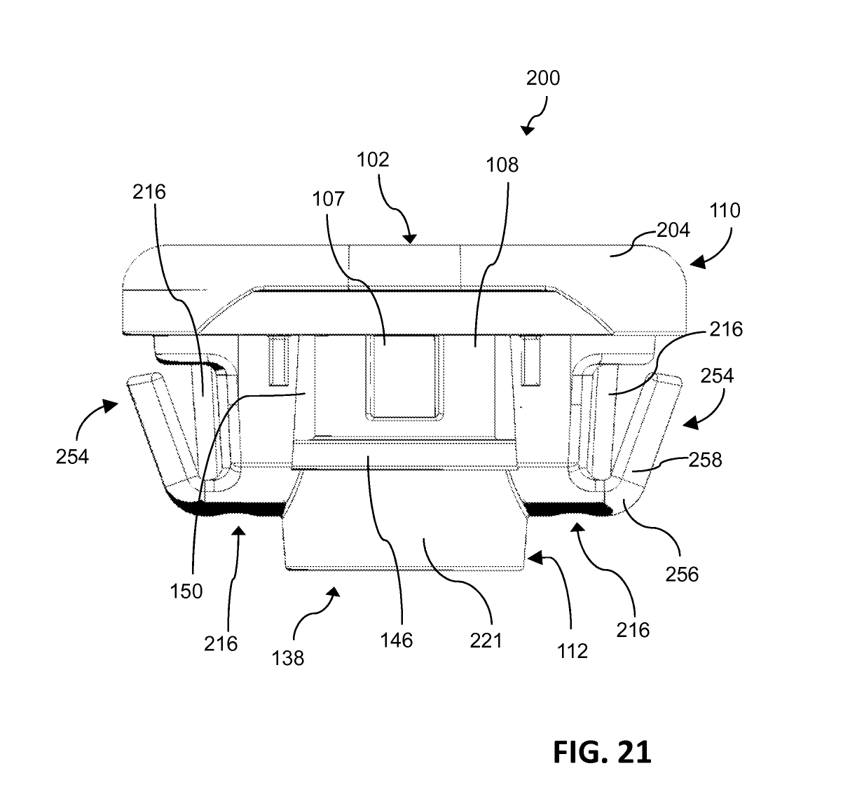

Also shown in FIG. 19, housing 204 may include base portion 221. As shown in FIG. 19, and in comparison to FIG. 3, base portion 221 of anchor assembly 200 may be substantially elongated or larger than base portion 121 of anchor assembly 100 (FIG. 3). As such, when spool 102 is inserted or positioned within housing 204, coupling structure 138 of spool 102 may be substantially surrounded by base portion 221. More specifically, as shown in FIG. 21, with reference to FIG. 19, coupling structure 138 of spool 102 may be substantially surrounded and not visible as a result of base portion 221 of housing 204 of anchor assembly 200. By surrounding coupling structure 138 of spool 102 with base portion 221 of housing 204, portions of cord 20 that may wrap around body 108 during the operation of anchor assembly 200 may not undesirably contact or become tangled with coupling structures 138. That is, the base portion 221 of housing 204, as shown in FIGS. 19 and 21, may substantially prevent cord 20 from being positioned below flange 146 of spool 102, and may prevent cord 20 from contacting coupling structure 138 of spool 102.

Housing 204 of anchor assembly 200 may also include a plurality of protrusions 254 positioned opposite one another and adjacent aperture 216 of housing 204. Protrusions 254 may couple housing 204 to bottom rail 14 (FIG. 18). More specifically, as shown in FIGS. 19 and 21, upon insertion of housing 204 within rail opening 30 of bottom rail 14 (FIG. 18), protrusions 254 of housing 204 may engage a surface opposite surface 32 of bottom rail 14 to substantially couple housing 204 of anchor assembly 200 to bottom rail 14, as discussed herein. In comparing FIGS. 5 and 21, it is understood that protrusions 254 of housing 204 (FIG. 21) may be larger than, and/or oriented in a different shape than protrusions 154 of housing 104 (FIG. 5). As shown in FIG. 21, protrusion 254 may include a first portion 256 coupled to housing 204 and positioned substantially parallel to flange 146 of spool 102, and an elongated second portion 258 positioned angularly adjacent to first portion 256. First portion 256 and/or second portion 258 may be substantially flexible, such that protrusion 254 may flex when inserted into opening 30 of bottom rail 14 (FIG. 18), and subsequently positioned below surface 32 of bottom rail 14 to couple housing 204 to window shade assembly 10, as discussed herein. Additionally, as similarly discussed herein, by inserting housing 204 within rail opening 30 and allowing protrusions 254 to engage the structural edges of rail opening 30, housing 204, and subsequently anchor assembly 200, may be coupled to and may be prevented from being removed from bottom rail 14 of window shade assembly 10.

As shown in and discussed herein, anchor assembly 100, 200 may receive cord 20 of window shade assembly 10 to adjust the overall length of window shade 12 and/or adjust the horizontal alignment of bottom rail 14. More specifically, as discussed herein, cord 20 may be received and/or enter anchor assembly 100, 200 along anchor assemblies 100, 200 rotational axis by being positioned through first opening 120 of housing 104, 204 and first and second apertures 106, 107 of spool 102. By positioning cord 20 in alignment with anchor assembly's 100, 200 axis of rotation (e.g., as cord 20 passes axially through first aperture 106 of spool 102), and in combination with securing end 124 of cord 20 to a component of window shade assembly 10 other than spool 102 (e.g., outside of housing 104, 204), undesirable torque on spool 102, caused by cord 20 tension, may be substantially minimized or eliminated during use of window shade assembly 10. That is, the combination of positioning cord 20 along the axis of rotation of anchor assembly 100, 200 and securing cord 20 to housing 104, 204 may substantially minimize or eliminate undesirable torque on spool 102, which may otherwise cause spool 102 to change position and/or release a portion of cord 20 wrapped around spool 102. By substantially minimizing or eliminating the undesirable torque caused by cord 20 tension, window shade assembly 10 utilizing anchor assembly 100, 200 may substantially prevent unwanted lengthening of window shade 12 and/or misalignment of bottom rail 14 caused by the undesirable change in position of spool 102 and/or the release a portion of cord 20 wrapped around spool 102.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A rail anchor assembly for a corded window shade, the rail anchor assembly comprising:
a spool including a first aperture for allowing a cord of the corded window shade to pass axially into an interior cavity of the spool; and a second aperture for allowing the cord to exit the interior cavity of the spool; and
a retaining component for affixing an end of the cord to a component of the window shade other than the spool.

2. The assembly of claim 1, further comprising a housing coupled to a rail of the window shade assembly and including the spool therein.

3. The assembly of claim 2, wherein the housing is positioned within a rail-opening of the rail.

4. The assembly of claim 2, wherein the housing includes the retaining component, and the housing is non-rotatable with respect to the rail.

5. The assembly of claim 4, wherein the retaining component comprises an aperture, and the end of the cord includes a knot positioned outside of the housing, wherein the knot is substantially larger than the aperture of the housing.

6. The assembly of claim 2, wherein the spool includes a tool engagement element positioned at a first end of the spool.

7. The assembly of claim 6, wherein the spool further includes an engagement structure positioned at a first end of the spool, and
wherein the housing includes an internal contact surface having a plurality of grooves for receiving the engagement structure of the spool to substantially secure the spool in a user-selected position within the housing.

8. The assembly of claim 6, wherein the spool includes a coupling structure positioned at a second end of the spool opposite the first end, the coupling structure for coupling the spool to the housing.

9. The assembly of claim 8, wherein the coupling structure is selected from a group consisting of: a snap-fit, a threaded fastener, a nut-and-bolt assembly, and a cotter pin.

10. The assembly of claim 1, wherein the spool is substantially rotatable within the rail.

11. The assembly of claim 1, wherein the rail comprises a bottom rail of the corded window shade.

12. The assembly of claim 1, wherein a rotation of the spool adjusts one of a length of the corded window shade and a level of a rail coupled to the corded window shade.

13. A window shade assembly comprising:
a corded window shade;
a rail coupled to the corded window shade;
a cord positioned through the corded window shade; and
a rail anchor assembly coupled to the rail, the rail anchor assembly including:
a spool including a first aperture for allowing the cord to pass axially into an interior cavity of the spool; and a second aperture for allowing the cord to exit the interior cavity of the spool; and
a retaining component for affixing an end of the cord to a component of the window shade other than the spool.

14. The assembly of claim 13, wherein a rotation of the spool of the rail anchor assembly adjusts one of a length of the corded window shade and a level of the rail.

15. A method for securing a cord within a rail of a window shade assembly, the method comprising:
threading the cord axially into an interior cavity of a spool through a first aperture of the spool;
threading the cord through a second aperture of the spool; and
affixing an end of the cord to a component of the window shade other than the spool.

16. The method of claim 15, further comprising coupling the spool to the rail to secure the cord to the component of the window shade other than the spool.

17. The method of claim 15, further comprising threading the cord through an aperture of a housing configured to receive the spool therein, wherein the component of the window shade other than the spool comprises the housing.

18. The method of claim 17, wherein the affixing of the end of the cord further comprises:
positioning the end of the cord including a knot outside of the housing, wherein the cord extends through an aperture of the housing.

19. The method of claim 15, wherein the first aperture of the spool is located substantially along an axis of rotation of the spool.

20. The method of claim 20, further comprising rotating the spool to adjust one of a length of the corded window shade and a level of the rail.
